(19) United States
(12) Patent Application Publication
(10) Pub. No.: US 2011/0016768 A1
(43) Pub. Date: Jan. 27, 2011

(54) FISHING APPARATUS AND METHOD

(76) Inventor: Joseph A. Tarquini, Rockford, IL (US)

Correspondence Address: REINHART BOERNER VAN DEUREN P.C., 2215 PERRYGREEN WAY, ROCKFORD, IL, 61107, US

(21) Appl. No.: 12/839,101

(22) Filed: Jul. 19, 2010

Related U.S. Application Data
(60) Provisional application No. 61/227,323, filed on Jul. 21, 2009.

(51) Int. Cl. A01K 83/06; A01K 99/00

(52) U.S. Cl. 43/44.2; 43/44.4

(57) ABSTRACT

A method and apparatus are provided for attaching a bait fish and a fish hook to a fishing line, by operatively attaching the fish hook to the skin of the bait fish with a specially shaped tack which penetrates and locks into the skin of the bait fish.

This patent application claims the benefit of U.S. Provisional Patent Application No. 61/227,323, filed Jul. 21, 2009, the entire teachings and disclosure of which are incorporated herein by reference thereto.

### FIELD OF THE INVENTION

This invention is directed to a rig for fishing with live bait, and more particularly to a rig suitable for fishing with various size bait fish, including those large enough to attract trophy size game fish such as musky and pike.

### BACKGROUND OF THE INVENTION

Despite the wide variety of artificial baits that are available in the marketplace for fishing, there are still circumstances where the use of a live bait fish is preferred. When utilizing live bait fish, it is typically necessary to provide some sort of a rig at the terminal end of a fishing line for presenting the bait fish in a more-or-less natural manner to a target fish, with the rig also including one or more fish hooks for catching the target fish once it strikes the live bait.

Although many configurations of such fishing rigs have been proposed and utilized with varying degrees of success through the years, none have proven to be entirely satisfactory. With the increased popularity of catch-and-release fishing in recent years, many of the rigs traditionally utilized have been shown to be unsuitable because they result in the target fish swallowing the bait along with the fishhook or hooking of the target fish in such a way that it is injured so severely that it would not likely survive if released.

In one type of live-bait fishing rig which has had some commercial success in recent years, commonly known as a “Herbie Rig,” a common safety pin is affixed to a treble hook attached by a hook leader to a snap fitting which is in turn operatively attached to the terminal end of the fishing line. A portion of the head between the bait fish's nostrils is punctured with a flexible wire or other suitable tool and a rubber band is fed in one nostril, passed through the hole in the fish's head, and out of the other nostril. The ends of the rubber band are then hooked to the snap. The safety pin is then utilized to pin the treble hook through the skin of the fish along the side of the fish. The Herbie Rig works on the principle that when the bait fish is struck by the target fish, the rubber band will snap and the safety pin will pull through and free from the fish's skin, while the target fish holds the bait fish in its mouth, when a strong hook-setting pull is applied to the fishing line. The treble hook is then free to embed itself within the mouth of the target fish, and will likely not be swallowed by the target fish. It is also generally believed that the Herbie Rig provides a higher percentage of successful hook sets than other types of rigs.

Experience has shown, however, that the Herbie Rig still results in an unacceptably high number of missed strikes, and instances of hooking the target fish in an undesirable manner. Specifically, it is difficult to reliably engage a small enough patch of skin with the safety pin to have the treble hook always break free of the skin of the fish, after the target fish takes the bait, or during the hook setting operation. Also, the safety pin holds the treble hook so closely against the side of the bait fish that it is sometimes not advantageously positioned to result in secure hooking of the target fish. Experience has shown, for example, that, as the hooks are set with a traditional Herbie Rig, the hooks are often driven into the bait fish rather than into the target fish.

Another disadvantage of Herbie Rigs is that they are highly visible, and unnatural looking, and may therefore serve to deter wary target fish from striking the bait fish.

It is desirable, therefore, to provide an improved rig arrangement for presenting a live bait fish to a target fish. It is particularly desirable to provide an improved rig that is capable of presenting a fairly large bait fish, on the order of 12 to 18 inches in length for use in fishing for large game fish, such as musky and pike.

### BRIEF SUMMARY OF THE INVENTION

The invention provides an improved method and apparatus for operatively attaching a bait fish and a fishhook to a fishing line, by operatively attaching the fishhook to the skin of the bait fish with a specially shaped tack which penetrates and locks into the skin of the fish.

In one form of the invention, the tack has a head portion and a shank portion, with the shank having a proximal end thereof fixedly attached to and extending from the head of the tack. The shank also has a distal end thereof which defines a point of the shank. The shank further has an intermediate section which is disposed between the proximal and distal ends of the shank, with the intermediate section of the shank also defining at least one reduced cross-sectional portion thereof. By virtue of this arrangement, the point of the shank may be pressed through the skin of the bait fish by application of pressure to the head portion of the tack opposite the shank, in such a manner that the intermediate section of the shank penetrates the skin of the fish to a depth whereat the skin about the shank constricts into the reduced cross-sectional portion for retaining the tack in the skin of the fish when pressure is removed from the head portion of the tack.

An apparatus, according to the invention, may also include the fishhook. In some embodiments of the invention, the apparatus may further include a stand-off leader attaching the fishhook to the tack. The stand-off leader may be attached to the head portion of the tack. To facilitate attachment of the stand-off leader to the head portion of the tack, the head portion of the tack may define a through-hole therein for passage therethrough of the stand-off leader. A stand-off leader may pass slidingly through the through-hole in the head of the tack, with the distal end of the stand-off leader being fixedly attached to the fishhook, and a proximal end of the stand-off leader being configured to bear against one side of the head of the tack. By virtue of this arrangement, the stand-off leader may only slide through the through-hole in the head of the tack until the proximal end of the stand-off leader comes to bear against the one side of the head portion of the tack.

An apparatus, according to the invention, may also include a hook leader having a proximal end thereof attached to and extending from the hook to a distal end of the hook leader. The hook leader may be pre-stretched after attachment to the fish hook. Such pre-stretching can improve hook setting, particularly when the hook leader is formed from a stretchable material such as a fluorocarbon. In some forms of the invention, the hook leader and the stand-off leader are formed from a single continuous length of leader material extending from the distal end of the hook leader to the proximal end of the stand-off leader. Some forms of the invention include an attachment loop affixed to the distal end of the hook leader.

An apparatus, according to the invention, may also include one or more components from the group of components consisting of: a main leader having proximal and distal ends thereof, with the proximal end of the main leader being adapted for attachment to the loop at the distal end of the hook leader and the distal end of the main leader being adapted for attachment thereto of the fishing line; a snap arrangement for attaching the distal end of the hook leader to the proximal end of the main leader; and/or an elastic band having opposite ends thereof adapted for attachment to the snap after passage of the elastic band through a through-hole in the fish. Some forms of the invention may include a second apparatus connected to a treble hook in accordance with the invention. In practicing the invention, the through-hole in the bait fish may extend through a portion of the head between the nostrils of the bait fish.

Some forms of the invention may also include at least one swivel fitting disposed between the distal end of the main leader and the bait fish. An apparatus, according to the invention, may also include at least one fish attracting device disposed between the distal end of the main leader and the bait fish. Such fish attracting devices may include colored beads, metal beads, spinners, skirts, bucktails, noisemakers, or any other form of a fish attracting device known in the art.

In some forms of the invention, the main leader may be pre-stretched before or after attachment to the fishhook. The main leader may be formed of a fluorocarbon material in some forms of the invention.

In some forms of the invention, the shank of the tack defines a substantially frusto-conical shape between the point and the reduced cross-sectional area of the shank. In one form of an apparatus according to the invention, the shank has a length of approximately 0.325 inches, a diameter of approximately 0.130 inches at a distance of 0.125 inches from the head portion and taper from there over a distance of approximately 0.200 inches to the point. The shank also has a diameter of approximately 0.050 inches for the distance of 0.125 inches from the head portion of the tack.

Some forms of the invention may have more than one reduced cross-sectional area of the shank.

In one form of the invention having only a single reduced cross-sectional area of the shank, proper attachment of the tack to the skin of the fish may be determined by the detection of two snapping sensations, with the first snapping sensation occurring when the point of the tack first penetrates the skin of the bait fish, and the second snapping sensation occurring as the skin of the fish around the tack constricts into the reduced cross-sectional area of the shank. In some forms of the invention, some or all of the components of a fishing rig, according to the invention, may be fabricated with materials that are less visible to the target fish. For example, in some forms of the invention the leaders are formulated from a transparent material such as fluorocarbon, so that they will be essentially invisible in the water when attached to the bait fish. In other embodiments of the invention, some or all of the components of a fishing rig may be colored to make them less visible, or alternatively, colored red to simulate blood trails streaming from an injured bait fish. In some embodiments of the invention, for example, the hooks, tacks, leaders and swivels, and indeed even the elastic band may all be colored red to simulate blood trailing from the bait fish. In this regard, red transparent leaders and red hooks have been shown to be particularly effective.

Those having skill in the art will recognize that the invention provides significant improvements over prior fishing rigs, such as the Herbie Rig. These improvements include the attachment of the hook to the skin of the fish being more repeatable through use of a tack according to the invention than could be achieved in the past through utilization of the safety pin of the Herbie Rig, or other types of previously known attachments. The presence of a stand-off leader in some forms of the present invention also results in presentation of the fishhook in an improved manner which has been shown to result in a higher percentage of successful hooksets than prior live-bait fishing rigs.

Other aspects, objects and advantages of the invention will be apparent from the following detailed description and accompanying drawings of exemplary embodiments.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIGS. 1 and 2 are a cross-section and end view, respectively of a first embodiment of the invention in the form of a specially shaped tack for operatively attaching a fish hook to the skin of a bait fish.

FIGS. 3-6 are sequential illustrations of the manner in which the specially shaped tack of FIGS. 1 and 2 may be used for attaching a hook to the skin of a bait fish.

FIGS. 7 and 8 are sequential illustrations showing steps in a method for using the invention, in which one or more scales are removed from a bait fish to expose an area of the skin of the bait fish for insertion of the specially shaped tack of FIGS. 1 and 2.

FIG. 9 illustrates another embodiment of the invention incorporating a fish hook in combination with the specially shaped tack of FIGS. 1 and 2, in addition to other elements and aspects of the invention.

FIG. 10 illustrates another embodiment of an apparatus, according to the invention, attached to a bait fish.

While the invention will be described in connection with certain preferred embodiments, there is no intent to limit it to those embodiments. On the contrary, the intent is to cover all alternatives, modifications and equivalents as included within the spirit and scope of the invention.

### DETAILED DESCRIPTION OF THE INVENTION

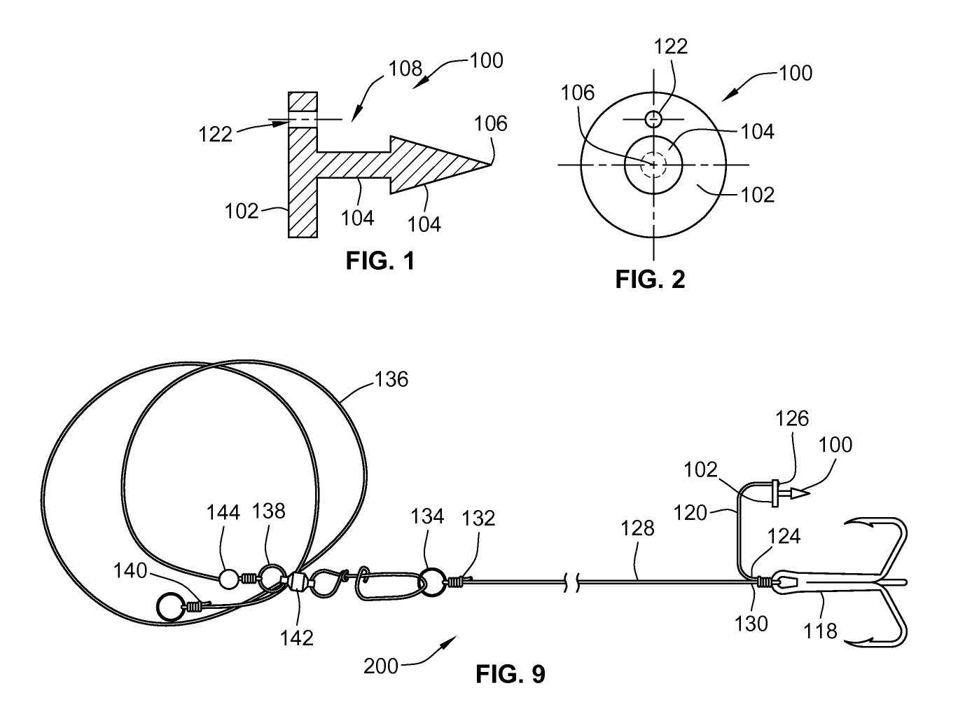

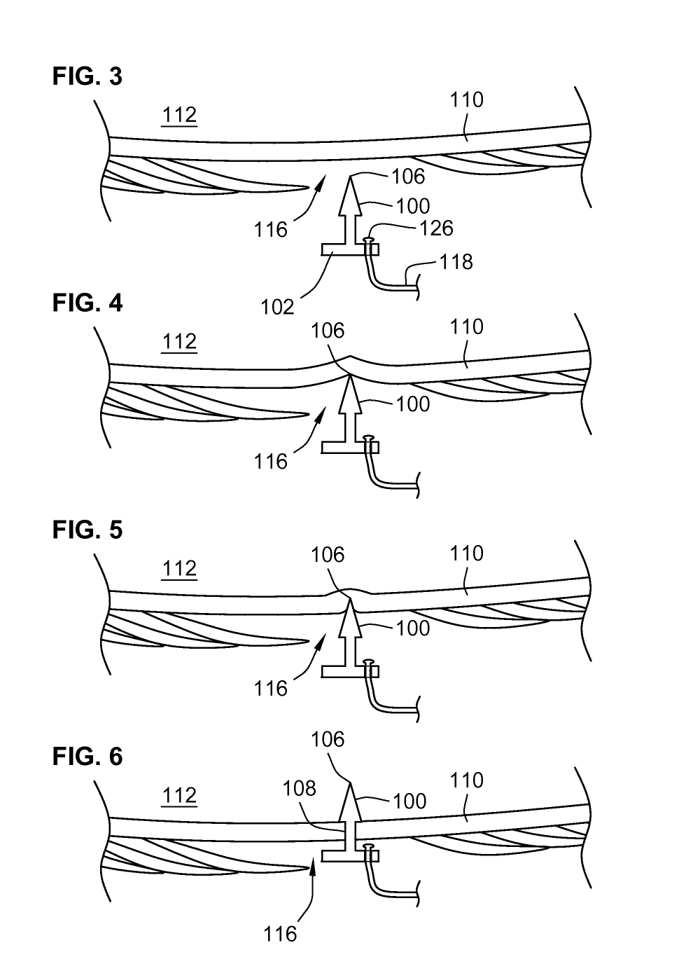

FIGS. 1 and 2 show a first exemplary embodiment of a specially shaped tack 100 which penetrates and locks into the skin of a fish, in the manner described in more detail below with particular reference to FIGS. 3-6, in accordance with methods and apparatuses for operatively attaching a bait fish and a fish hook to a fishing line.

The exemplary embodiment of the tack 100 has a head portion 102 and a shank portion 104, with the shank 104 having a proximal end thereof fixedly attached to and extending from the head 102 of the tack 100. The shank 104 also has a distal end 106 thereof which defines a point 106 of the shank 104. The shank 104 of the tack 100 further has an intermediate section 108 which is disposed between the proximal and distal ends of the shank 104, with the intermediate section 108 of the shank 104 also defining at least one reduced cross-sectional portion thereof.

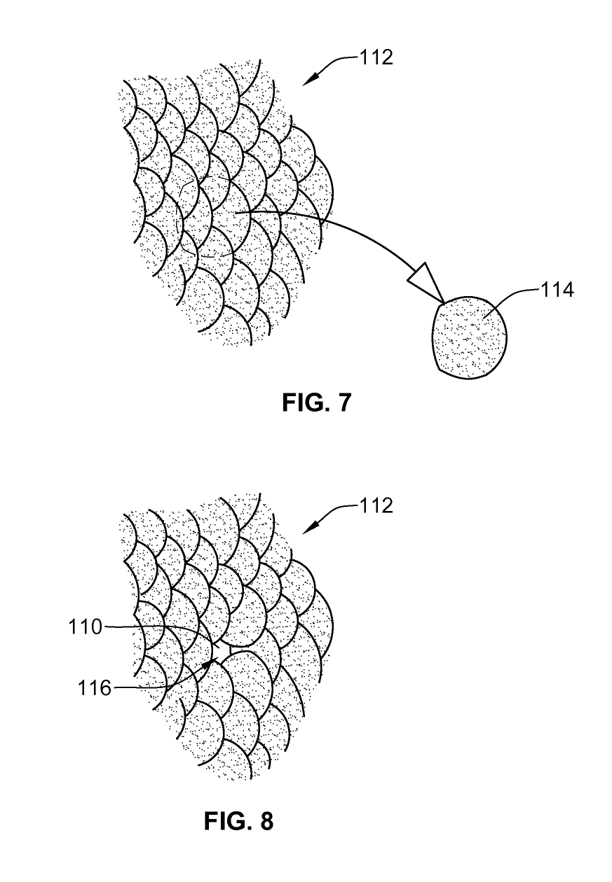

As illustrated sequentially in FIG. 3-6, by virtue of the above described configuration of the exemplary embodiment of the tack 100, the point 106 of the shank 104 may be pressed through the skin 110 of a bait fish 112 by application of pressure to the head portion 102 of the tack 100 opposite the shank 104, in such a manner that the intermediate section 108 of the shank 104 penetrates the skin 110 of the fish 112 to a depth whereat the skin 110 about the shank 104 constricts into the reduced cross-sectional intermediate portion 108, in the manner shown in FIG. 6, for retaining the tack 100 in the skin 110 of the fish 112 when pressure is removed from the head portion 102 of the tack 100. As illustrated in FIGS. 7 and 8, in accordance with a method for using the invention, prior to the tack 100 being pressed through the skin 110 of the bait fish 112, one or more scales 114 are removed from the skin 110 of the fish 112 to create an exposed area 116 of the skin 110 into which the point 106 of the tack 100 can be pressed.

FIG. 9 illustrates a second embodiment of an apparatus 200, according to the invention, which also includes a fish hook 118. In the second embodiment, the apparatus 200 further includes a stand-off leader 120 attaching the fish hook 118 to the tack 100. In the embodiment 200 shown in FIG. 9, the stand-off leader 120 is attached to the head portion 102 of the tack 100.

To facilitate attachment of the stand-off leader 120 to the head portion 102 of the tack 100, the head portion 102 of the tack 100 defines a through-hole 122 therein (see FIGS. 1 and 2) for passage therethrough of the stand-off leader 120. In the exemplary embodiment, the stand-off leader 120 passes slidingly through the through-hole 122 in the head 102 of the tack 100, with a distal end 124 of the stand-off leader 120 being fixedly attached to the fish hook 118, and a proximal end 126 of the stand-off leader 120 being configured to bear against one side of the head 102 of the tack 100. In the exemplary embodiment of the apparatus 200, the stand-off leader 120 is formed from a meltable material such as fluorocarbon, and the proximal end 126 of the stand-leader 120 is formed into a ball of large enough cross-section to preclude the proximal end 126 from sliding back through the hole 122 in the head 102 of the tack 100, through application of heat to the proximal end 126 of the stand-off leader 120. By virtue of this arrangement, this stand-off leader 120 may only slide through the through-hole 122 in the head 102 of the tack 100 until the proximal end 126 of the stand-off leader 120 comes to bear against one side of the head portion 102 of the tack 100.

The exemplary embodiment of the apparatus 200 also includes a hook leader 128 having a proximal end 130 thereof attached to and extending from the hook 118 to a distal end 132 of the hook leader 128 having a split ring 134 attached thereto. It is contemplated that in some embodiments of the invention the hook leader 128 may be pre-stretched after attachment to the fish hook 118. Such pre-stretching can improve hook setting, particularly where the hook leader 128 is formed from a stretchable material such as a fluorocarbon. In some forms of the invention, such as the one shown in FIG. 9, the hook leader 128 and the stand-off leader 120 are formed from a single continuous length of leader material extending from the distal end 132 of the hook leader 128 to proximal end 126 of the stand-off leader 120.

As further shown in FIG. 9, the exemplary embodiment of the apparatus 200, according to the invention, also includes a main leader 136 having proximal and distal end 138, 140, with the proximal end 138 of the main leader 136 being adapted through a swivel snap fitting 142 for attaching the distal end 132 of the hook leader 128 to the proximal end 138 of the main leader 136. The exemplary embodiment of the apparatus 200, as shown in FIG. 9 also includes a fish attracting device, in the form of a colored bead 144 disposed between the distal end 140 of the main leader 136 and the bait fish 112. It is understood that in various embodiments of the invention, such fish attracting devices may include colored beads, metal beads, spinners, skirts, buck tails, noise makers, or any other form of fish attracting device known in the art.

In some forms of the invention it is contemplated that the main leader 136 may be pre-stretched before or after attachment to the fish hook 118. The main leader 136 may be formed of a fluorocarbon material in some forms of the invention.

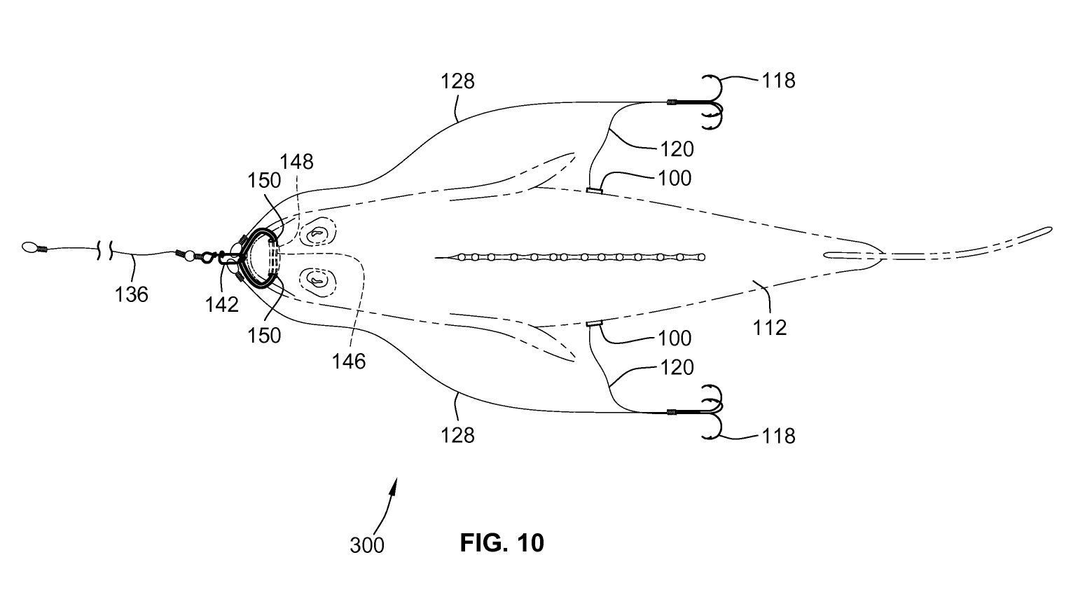

FIG. 10 illustrates another exemplary embodiment of an apparatus 300, according to the invention, in which a pair of treble hooks 118 are attached to a bait fish 112 using a pair of tacks 100, in the manner described above. Both of the treble hooks 118 in the embodiment shown in FIG. 10 are connected to a respective one of the tacks 100 through a respective stand-off leader 120. The treble hooks 118 are each further connected by a respective hook leader 128 to the swivel snap fitting 142 of a common main leader 136. As further illustrated in FIG. 10, the exemplary embodiment of the apparatus 300 also includes an elastic band 146 extending through a through-hole 148 in the bait fish 112. As shown in FIG. 10, the through-hole 148 in the bait fish 112 extends through a portion of the head (not shown) between the nostrils 150 of the bait fish 112, in the manner known in the art to those familiar with the Herbie Rig described in the Background section of this patent application.

Those having skill in the art will recognize that, although a tack 100 according to the invention having only a single reduced diameter intermediate section 108 have been described herein, in other forms of the invention a tack in accordance with the invention may have more than one reduced cross-sectional area of the shank.

As illustrated sequentially in FIGS. 3-6, in forms of the invention having only a single reduced cross-sectional area 108 of the shank of the tack 100, proper attachment of the tack 100 to the skin 110 of the fish 112 may be determined by the detection of two snapping sensations. The first such snapping sensation occurs when the point 106 of the tack 100 first penetrates the skin 110 of the bait fish 112, as illustrated in FIG. 5. The second snapping sensation occurs after the point 106 of the tack 100 has fully penetrated the skin 110 of the fish 112, as the skin 110 of the fish 112 around the tack 100 constricts into the reduced cross-sectional area 108 of the shank 104.

Those having skill in the art will recognize that the invention may be practiced in a variety of methods and apparatuses in accordance with the disclosure herein, in various combinations of the elements and aspects of the invention described herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An apparatus for attaching a fish hook to the skin of a bait fish for operatively attaching the bait fish and the fish hook to a fishing line, the apparatus comprising, a tack for operative attachment thereto of the fish hook, the tack having a head portion and a shank portion, the shank portion having a proximal end thereof fixedly attached to and extending from the head, the shank also having a distal end thereof defining a point, the shank further having an intermediate section thereof disposed between the proximal and distal ends of the shank, with the intermediate section of the shank defining at least one reduced cross sectional portion thereof, whereby the point of the shank may be pressed through the skin of the bait fish by application of pressure to the head portion of the tack opposite the shank in such a manner that the intermediate section of the shank penetrates the skin of the fish to a depth whereat the skin about the shank constricts into the reduced cross sectional portion for retaining the tack in the skin of the fish when pressure is removed from the head portion of the tack.

2. The apparatus of claim 1, further comprising, the fish hook.

3. The apparatus of claim 2, further comprising, a stand-off leader attaching the fish hook to the tack.

4. The apparatus of claim 3, wherein, the stand-off leader is attached to the head portion of the tack.

5. The apparatus of claim 4, wherein, the head portion of the tack defines a through-hole therein for passage therethrough of the stand-off leader.

6. The apparatus of claim 5, wherein, the stand-off leader passes slidingly through the through hole, with a distal end of the stand-off leader being fixedly attached to the fish hook, and with a proximal end of the stand-off leader being configured to bear against one side of the head of the tack, such that the stand-off leader may only slide through the through hole until the proximal end of the stand-off leader comes to bear against the one side of the head portion of the tack.

7. The apparatus of claim 6, further comprising, a hook leader having a proximal end thereof attached to and extending from the hook to a distal end of the hook leader.

8. The apparatus of claim 7, wherein, the hook leader is pre-stretched after attachment to the fish hook.

9. The apparatus of claim 8, wherein, the hook leader is formed from a fluorocarbon material.

10. The apparatus of claim 7, wherein, the hook leader and the stand-off leader are formed from a continuous length of leader material extending from the distal end of the hook leader to the distal end of the stand-off leader.

11. The apparatus of claim 10, wherein, at least one of the stand-off leader and the hook leader is pre-stretched after attachment to the fish hook.

12. The apparatus of claim 11, wherein, the leader material is a fluorocarbon material.

13. The apparatus of claim 10, further comprising, an attachment loop affixed to the distal end of the hook leader.

14. The apparatus of claim 13, further comprising, one or more component from the group consisting of:
a main leader having proximal and distal ends thereof, with the proximal end of the main leader being adapted for attachment to the loop at the distal end of the hook leader and the distal end of the main leader being adapted for attachment thereto of the fishing line;
a snap arrangement for attaching the distal end of the hook leader to the proximal end of the main leader; and
an elastic band having opposite ends thereof adapted for attachment to the snap after passage of the elastic band through a through-hole in the fish.

15. The apparatus of claim 14, further comprising, a second apparatus in accordance with claim 13.

16. The apparatus of claim 14, wherein, the through-hole extends through a portion of the head between the nostrils of the bait fish.

17. The apparatus of claim 14, further comprising, at least one swivel fitting disposed between the distal end of the main leader and the bait fish.

18. The apparatus of claim 14, further comprising, at least one fish attracting device disposed between the distal end of the main leader and the bait fish.

19. The apparatus of claim 14, wherein, at least one of the main leader, the stand-off leader or the hook leader is pre-stretched after attachment to the fish hook.

20. The apparatus of claim 14, wherein, the main leader material is a fluorocarbon material.

21. The apparatus of claim 1, wherein, the shank defines a substantially frusto-conical shape between the point and the reduced cross sectional area.

22. The apparatus of claim 21, wherein, the shank has a length of approximately 0.325 inches, a diameter of approximately 0.130 inches at a distance of 0.125 inches from the head portion tapering from there over a distance of approximately 0.200 inches to the point, and a diameter of approximately 0.050 inches for the distance of 0.125 inches from the head portion of the tack.

23. A method for attaching a fish hook to the skin of a bait fish for operatively attaching the bait fish and the fish hook to a fishing line, by operatively attaching the fish hook to the skin of the fish with a tack penetrating the skin of the fish.

24. The method of claim 23, further comprising, removing one or more scales from the fish to expose a portion of the skin of the fish penetrated by the tack.

25. The method of claim 24, wherein, the tack has a head portion and a shank portion, the shank portion having a proximal end thereof fixedly attached to and extending from the head, the shank also having a distal end thereof defining a point, the shank further having an intermediate section thereof disposed between the proximal and distal ends of the shank, with the intermediate section of the shank defining at least one reduced cross sectional portion thereof, whereby the point of the shank may be pressed through the skin of the bait fish by application of pressure to the head portion of the tack opposite the shank in such a manner that the intermediate section of the shank penetrates the skin of the fish to a depth whereat the skin about the shank constricts into the reduced cross sectional portion for retaining the tack in the skin of the fish when pressure is removed from the head portion of the tack.
